(19) United States
(12) Patent Application Publication
(10) Pub. No.: US 2020/0079141 A1
(43) Pub. Date: Mar. 12, 2020

(54) CARRIER-TYPE SAND ART EXPERIENCE BOX

(71) Applicants: Youngja YU, Seoul (KR); Sangkyung LEE, Incheon (KR)

(72) Inventors: Youngja YU, Seoul (KR); Sangkyung LEE, Incheon (KR)

(21) Appl. No.: 16/565,571

(22) Filed: Sep. 10, 2019

(30) Foreign Application Priority Data
Sep. 10, 2018 (KR) 10-2018-0107545

(51) Int. Cl. B44D 3/22

(52) U.S. Cl. CPC B44D 3/22

(57) ABSTRACT

Disclosed herein is a carrier-type sand art experience box in which various patterns are formed by scattering sand and a work of art is formed by radiating light. The carrier-type sand art experience box includes: a box-shaped case body inside which is formed a space part, and on the top of which is formed an edge part; art glass which is seated inside the edge part of the case body, and on which sand is scattered; a backlight which radiates various types of light onto art sand formed by a user from a surface below the art glass; a control unit which is seated on one side of the case body, which controls the backlight, and which is provided with an on/off switch; and a cover which selectively opens and closes the top of the case body, and which surrounds the art glass.

### CROSS-REFERENCE TO RELATED APPLICATION

This application claims the benefit of Korean Patent Application No. 10-2018-0107545 filed on Sep. 10, 2018, which is hereby incorporated by reference herein in its entirety.

### BACKGROUND

### 1. Technical Field

The present invention relates generally to a carrier-type sand art experience box, and more specifically to a carrier-type sand art experience box art which can prevent sand scattered on an art glass from being removed because a box-shaped case body provided with an edge part is provided, which enables long-term stable use because the strength of the edge part is reinforced, which enables a user to easily form art sand having various patterns because an art glass is seated inside the edge part of the case body, which can improve beauty by radiating various types of light onto art sand formed by a user, which enables a user to conveniently carry or move the experience box like a carrier, which can improve the beauty of appearance by radiating light having various patterns via the backlight, and which enables many people to view and experience art sand having various patterns illuminated with the backlight because the art sand having various patterns is relayed in real time.

### 2. Description of the Related Art

Generally, sand art refers to art in which fine sand is scattered on an illuminated transparent plate and various pictures are expressed using the sand.

In order to enjoy the above-described sand art, a sand box for sand art should be provided. The sand box for sand art is configured such that a rectangular frame-shaped box is equipped with an expression plate which allows sand to be scattered thereon. Usually, an illumination is further installed inside the box, and light is radiated onto the expression plate from the illumination.

The above-described sand art using the sand box for sand art may be performed in addition to commentary while being broadcast in real time, or may be performed as a performance at an event.

Furthermore, an expressed picture may be photographed by a camera, and the audience may view it through a large screen.

Meanwhile, the conventional sand box for sand art is problematic in that breakage occurs frequently because the conventional sand box must be move frequently and successively and the movement is inconvenient due to the large-volume sand box for sand art.

Furthermore, a problem arises in that even an unnecessary sand art part is expressed because the illumination radiated onto sand art is radiated onto the overall glass plate.

Moreover, a problem arises in that the beauty of appearance is poor because the sand box for sand art is formed in a rectangular box shape.

Therefore, there is an urgent need for the development of a sand box for sand art which is used for gradually spreading sand art.

### SUMMARY

The present invention has been conceived to overcome the above-described problems, and an object of the present invention is to provide a carrier-type sand art experience box art which can prevent sand scattered on an art glass from being removed because a box-shaped case body provided with an edge part is provided, which enables long-term stable use because the strength of the edge part is reinforced, which enables a user to easily form art sand having various patterns because an art glass is seated inside the edge part of the case body, which can improve beauty by radiating various types of light onto art sand formed by a user, which enables a user to conveniently carry or move the experience box like a carrier, which can improve the beauty of appearance by radiating light having various patterns via the backlight, and which enables many people to view and experience art sand having various patterns illuminated with the backlight because the art sand having various patterns is relayed in real time.

In order to accomplish the above object, the present invention provides a carrier-type sand art experience box in which various patterns are formed by scattering sand and a work of art is formed by radiating light, the carrier-type sand art experience box including: a box-shaped case body inside which is formed a space part, and on the top of which is formed an edge part; art glass which is seated inside the edge part of the case body, and on which sand is scattered; a backlight which radiates various types of light onto art sand formed by a user from a surface below the art glass; a control unit which is seated on one side of the case body, which controls the backlight, and which is provided with an on/off switch; and a cover which selectively opens and closes the top of the case body, and which surrounds the art glass.

An edge reinforcing portion made of metal may be coupled to the outer circumference of the edge part of the case body in order to reinforce the strength of the edge part; and body reinforcing portions made of metal may be coupled to the outsides of the corners of the case body in order to reinforce the strength of the case body.

A plurality of casters which rolls during movement may be coupled to one side of the case body in order to facilitate movement. An illumination pattern part, in which a letter or pattern is engraved, may be additionally formed in the outside of the space part of the case body so that light is radiated onto the illumination pattern part via the backlight.

A transparent portion which transmits light, radiated by the backlight, therethrough so that the light illuminates sand forming a work of art may be formed in the inside of the art glass, and an opaque portion which prevents light, radiated by the backlight, from being transmitted therethrough may be formed in the outer circumferential portion of the art glass.

A camera stand, to which a video camera configured to relay art sand having various patterns, illuminated with the backlight, in real time is fastened, may be additionally provided on the outer circumference of the edge part of the case body.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a photo showing the overview of a sand art experience box according to the present invention;

FIG. 2 is a photo showing the overview of a case body according to the present invention;

FIG. 3 is a photo showing casters used for the movement of the sand art experience box according to the present invention; and

FIG. 4 is a photo showing a real-time relay state according to the present invention.

### DETAILED DESCRIPTION

Embodiments of the present invention will be described in detail below with reference to the accompanying drawings.

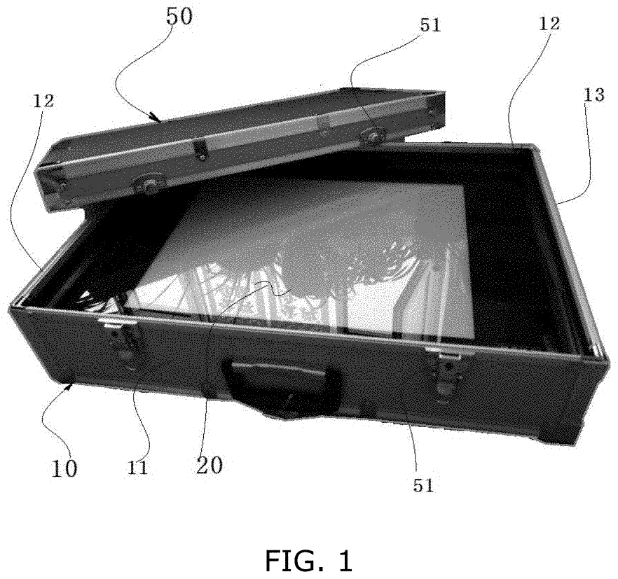

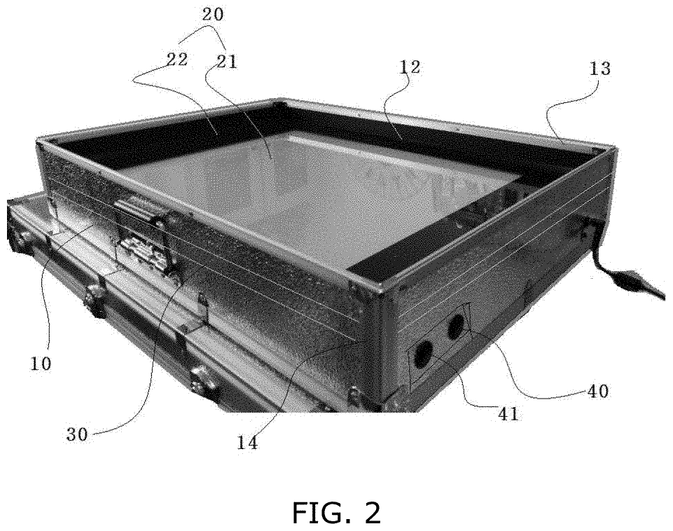

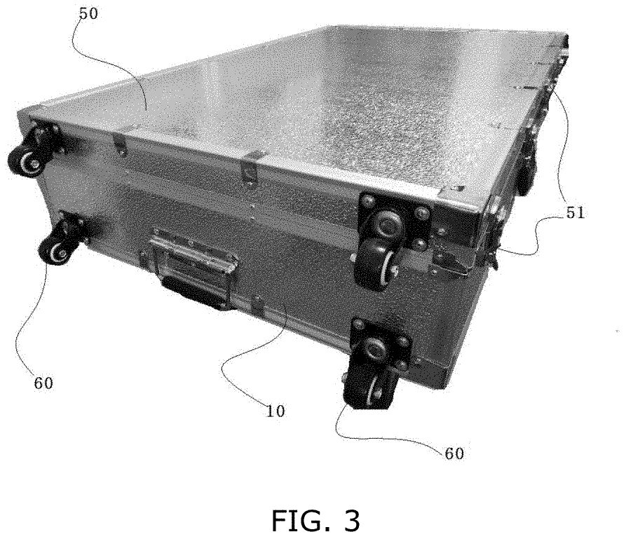

As shown in FIGS. 1 to 3, a carrier-type sand art experience box according to the present invention is a sand art experience box in which sand is scattered by a user with his or her hands and light is radiated to form various patterns, thereby forming a work of art. The carrier-type sand art experience box includes: a box-shaped case body 10; art glass 20 on which sand is scattered; a backlight 30 which radiates various types of light onto art sand A; a control unit 40 which controls the backlight 30 and is provided with an on/off switch 41; and a cover 50 which surrounds the art glass 20.

A rectangular space part 11 which accommodates the backlight 30 and the control unit 40 is formed inside the box-shaped case body 10, and an edge part 12 which protrudes upward in a stepped shape is formed on the top of the box-shaped case body 10.

The art glass 20 is seated inside the edge part 12 of the case body 10, and sand is scattered on the art glass 20 by a user with his or her hands to form a work of art. The art glass 20 includes: a transparent portion 21 which transmits light, radiated by the backlight 30, therethrough so that the light illuminates the sand forming a work of art; and an opaque portion 22 which is formed in the outer circumferential portion of the art glass 20, and which prevents light, radiated by the backlight 30, from being transmitted therethrough.

The backlight 30 radiates various types of light onto art sand A formed by a user with his or her hands from a surface below the art glass 20.

The control unit 40 is seated on one side of the case body 10, controls the backlight 30, and is provided with the on/off switch 41.

The cover 50 surrounds the art glass 20, and selectively opens and closes the top of the case body 10.

An edge reinforcing portion 13 made of metal is preferably coupled to the outer circumference of the edge part 12 of the case body 10 in order to reinforce the strength of the edge part 12, and body reinforcing portions 14 made of metal are preferably coupled to the outsides of the corners of the case body 10 in order to reinforce the strength of the case body 10.

Furthermore, a plurality of casters 60 which rolls during movement may be coupled to one side of the case body 10 in order to facilitate movement.

An illumination pattern part 15, in which a letter or pattern is engraved, is additionally formed in the outside of the space part 12 of the case body 10 so that light is radiated onto the illumination pattern part 15 via the backlight 30.

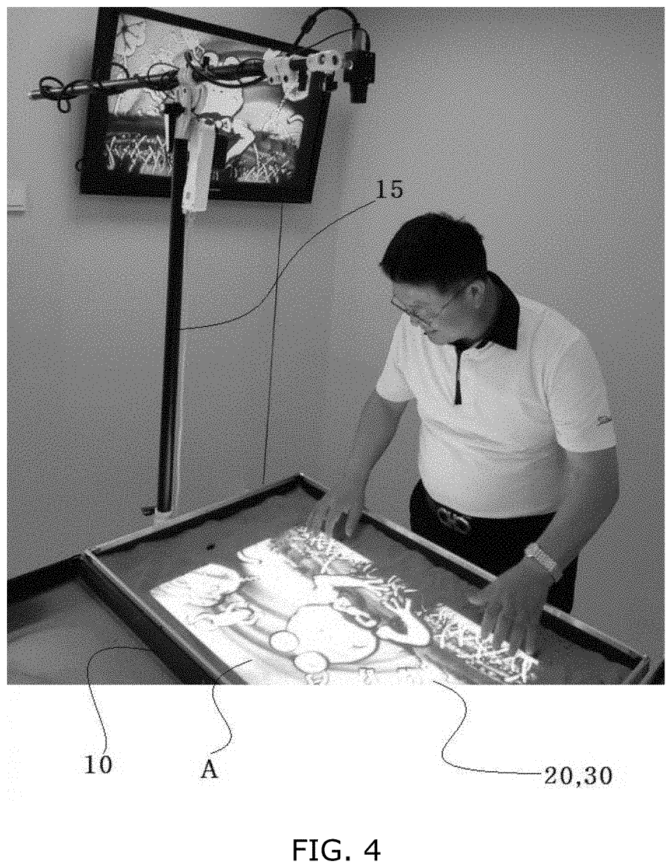

In FIG. 4, it is preferable that a camera stand 16, to which a video camera configured to relay art sand having various patterns, illuminated with the backlight 30, in real time is fastened, be additionally provided on the outer circumference of the edge part 12 of the case body 10.

The operation of the carrier-type sand art experience box according to the present invention, which is configured as described above, will be described below.

As shown in FIGS. 1 to 3, the carrier-type sand art experience box according to the present invention is configured in such a manner that the art glass 20 on which sand is scattered by a user with his or her hands is seated inside the box-shaped case body 10, the backlight 30 which radiates various types of light onto the art sand A is disposed below the art glass 20, the control unit 40 connected to the backlight 30 controls the backlight 30, and is provided with the on/off switch 41 and selectively performs turning on/off, and the cover 50 which surrounds the art glass 20 selectively opens and closes the top of the case body 10.

The rectangular space part 11 is formed inside the box-shaped case body 10, and the backlight 30 and the control unit 40 are accommodated in and fastened to the rectangular space part 11. The edge part 12 which protrudes upward in a stepped shape is formed on the top of the box-shaped case body 10, and prevents the art sand A scattered on the art glass 20 from being removed.

Furthermore, the edge reinforcing portion 13 made of metal is coupled to the outer circumference of the edge part 12 of the case body 10, thereby reinforcing the strength of the edge part 12 and thus enabling long-term stable use. The body reinforcing portions 14 made of metal are coupled to the outsides of the corners of the case body 10, thereby reinforcing the strength of the case body 10 and thus enabling long-term stable use.

The art glass 20 is seated inside the edge part 12 of the case body 10, and sand is scattered on the art glass 20 by a user with his or her hands to form the art sand A. The transparent portion 21 which transmits radiated light therethrough is formed in the center portion of the art glass 20, and allows light to illuminate the sand which forms various patterns. The opaque portion 22 which prevents radiated light from being transmitted therethrough is disposed in the outer circumferential portion of the art glass 20, and blocks light radiated by the backlight 30. Accordingly, people cannot see the sand which is scattered on the outer circumferential portion of the art glass 20.

The backlight 30 is composed of RGB LEDs, and radiates various types of light onto the art sand A, formed by a user, from a surface below the art glass 20.

The control unit 40 is seated on one side of the case body 10, and controls the strength and color of light radiated by the backlight 30. Furthermore, the control unit 40 is provided with the on/off switch 41, and thus a user can easily perform turning on/off.

The cover 50 surrounds the art glass 20, and selectively opens and closes the top of the case body 10. Accordingly, the cover 50 protects the art glass, and enables the experience box to be easily carried like a carrier.

Furthermore, the plurality of casters 60 which rolls during movement is coupled to one side of the case body 10, thereby enabling a user to conveniently carry or move the experience box like a carrier.

The illumination pattern part 15, in which a letter or pattern is engraved, is additionally formed in the outside of the space part 12 of the case body 10, and thus light having various patterns is radiated via the backlight 30, thereby improving the beauty of appearance.

As shown in FIG. 4, the camera stand 16, to which a video camera is fastened, is additionally seated on the outer circumference of the edge part 12 of the case body 10, and thus art sand having various patterns illuminated with the backlight 30 can be relayed in real time and viewed by many people.

The above-described carrier-type sand art experience box according to the present invention has the following advantages:

First, art sand scattered on the art glass can be prevented from being removed because the box-shaped case body inside which is formed the rectangular space part and on top of which is formed the edge part protruding upward in a stepped shape is provided;

Second, the strength of the edge part is reinforced and thus long-term stable use is enabled because the edge reinforcing portion made of metal is coupled to the outer circumference of the edge part of the case body, and the strength of the case body is reinforced and thus long-term stable use is enabled because the body reinforcing portions made of metal are coupled to the outsides of the corners of the case body;

Third, art sand having various patterns can be easily formed by a user because the art glass is seated inside the edge part of the case body, art sand having various patterns can be illuminated with light because the transparent portion which transmits radiated light therethrough is formed in the center portion of the art glass, and light radiated by the backlight is blocked and thus the sand scattered on the outer circumferential portion of the art glass cannot be viewed because the opaque portion which prevents radiated light from being transmitted therethrough is disposed in the outer circumferential portion of the art glass;

Fourth, various types of light can be radiated onto the art sand formed by a user from a surface below the art glass because the backlight composed of RGB LEDs is provided;

Fifth, the art glass can be protected and also the experience box can be easily carried because the cover which surrounds the art glass and selectively opens and closes the top of the case body is provided;

Sixth, a user can conveniently carry or move the experience box like a carrier because the plurality of casters which rolls during movement is coupled to one side of the case body;

Seventh, the beauty of appearance is improved by radiating light having various patterns via the backlight because the illumination pattern part in which a letter or pattern is engraved is additionally formed in the outside of the case body; and

Eighth, art sand having various patterns illuminated with the backlight can be relayed in real time and viewed and experienced by many people because the camera stand to which a video camera is fastened is additionally seated on the outer circumference of the edge part of the case body.

Although the preferred embodiments of the present invention have been described, it is apparent that all technologies which can be easily modified and used by those skilled in the art to which the present invention pertains, as well as modified examples which can be obtained by simple combination with conventional known technologies, should be construed as being included in the scope of the present invention.

What is claimed is:

1. A carrier-type sand art experience box in which various patterns are formed by scattering sand and a work of art is formed by radiating light, the carrier-type sand art experience box comprising:
a box-shaped case body (10) inside which is formed a space part (11), and on a top of which is formed an edge part (12);
art glass (20) which is seated inside the edge part (12) of the case body (10), and on which sand is scattered;
a backlight (30) which radiates various types of light onto art sand (A) formed by a user from a surface below the art glass (20);
a control unit (40) which is seated on one side of the case body (10), which controls the backlight (30), and which is provided with an on/off switch (41); and
a cover (50) which selectively opens and closes a top of the case body (10), and which surrounds the art glass (20).

2. The carrier-type sand art experience box of claim 1, wherein:
an edge reinforcing portion (13) made of metal is coupled to an outer circumference of the edge part (12) of the case body (10) in order to reinforce a strength of the edge part (12); and
body reinforcing portions (14) made of metal are coupled to outsides of corners of the case body (10) in order to reinforce a strength of the case body (10).

3. The carrier-type sand art experience box of claim 1, wherein a plurality of casters (60) which rolls during movement is coupled to one side of the case body (10) in order to facilitate movement.

4. The carrier-type sand art experience box of claim 2, wherein a plurality of casters (60) which rolls during movement is coupled to one side of the case body (10) in order to facilitate movement.

5. The carrier-type sand art experience box of claim 3, wherein an illumination pattern part (15), in which a letter or pattern is engraved, is additionally formed in an outside of the space part (12) of the case body (10) so that light is radiated onto the illumination pattern part (15) via the backlight (30).

6. The carrier-type sand art experience box of claim 1, wherein a transparent portion (21) which transmits light, radiated by the backlight (30), therethrough so that the light illuminates sand forming a work of art is formed in an inside of the art glass (20), and an opaque portion (22) which prevents light, radiated by the backlight (30), from being transmitted therethrough is formed in an outer circumferential portion of the art glass (20).

7. The carrier-type sand art experience box of claim 1, wherein a camera stand (16), to which a video camera configured to relay art sand having various patterns, illuminated with the backlight (30), in real time is fastened, is additionally provided on an outer circumference of the edge part (12) of the case body (10).
